(19) United States
(12) Patent Application Publication
(10) Pub. No.: US 2012/0297134 A1
(43) Pub. Date: Nov. 22, 2012

(54) System and Method to Isolate Passive Disk Transfers to Improve Storage Performance

(75) Inventors: Akshai Parthasarathy, Austin, TX (US); Anthony Fernandez, Austin, TX (US); Varun Kulkarni, Austin, TX (US)

(73) Assignee: DELL PRODUCTS, LP, Round Rock, TX (US)

(21) Appl. No.: 13/108,100

(22) Filed: May 16, 2011

(51) Int. Cl. G06F 12/00

(52) U.S. Cl. 711/114; 711/E12.001

(57) ABSTRACT

A storage system includes a storage controller, a storage array coupled to the storage controller, and a temporary storage device coupled to the storage controller. The storage array is operated as a redundant array of independent drives (RAID) array and includes a high priority storage volume and a low priority storage volume. The storage controller stores high priority data transfers on the high priority volume, stores low priority data transfers on the temporary storage device, and moves the low priority data transfers to the low priority volume in response to a condition of the storage system.

### FIELD OF THE DISCLOSURE

The present disclosure generally relates to information handling systems, and more particularly relates to isolating passive disk transfers to improve storage performance in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, and networking systems. Information handlings systems can also implement various virtualized architectures.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIGS. 1 and 2 are block diagrams of information handling systems according to different embodiments of the present disclosure;

FIGS. 3-5 are block diagram of network storage systems according to different embodiments of the present disclosure;

FIGS. 6-9 are flowcharts illustrating a method of implementing a storage system according to an embodiment of the present disclosure; and

FIG. 10 is a block diagram of an information handling system according to another embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings. Other teachings can be used in this application, and the teachings can be used in other applications and with different types of architectures, such as a client-server architecture, a distributed computing architecture, or a middleware server architecture and associated resources.

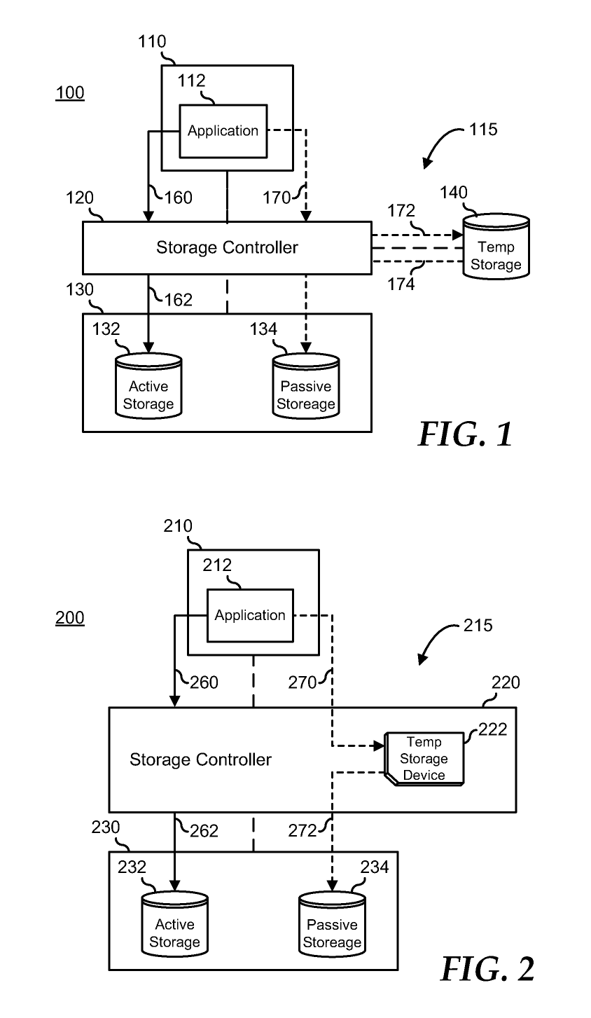

FIG. 1 illustrates an embodiment of an information handling system 100. For purposes of this disclosure, the information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

Information handling system 100 includes a processing subsystem 110 and a storage subsystem 115. Processing subsystem 110 includes an application 112. Storage subsystem 115 includes a storage controller 120, a storage array 130, and a temporary storage device 140. Storage array 130 includes storage volumes 132 and 134, and can include one or more additional storage volumes, as needed or desired. Storage controller 120 is connected to processing subsystem 110, to storage array 130, and to temporary storage device 140, as illustrated by the dashed lines. Storage controller 120 operates to transfer data between processing subsystem 110 and storage array 130. The data transfers include data reads from storage array 130 and data writes to the storage array. The rate for data transfers between processing subsystem 110 and storage controller 120, and between the storage controller and storage array 130, are limited by maximum transaction bandwidths between the respective elements. In a particular embodiment, the maximum transaction bandwidth between storage controller 120 and storage array 130 is limited by the speed at which a disk drive can move its read head to properly position itself to read from or write to the correct location, referred to as a disk I/O utilization. The maximum transaction bandwidth between the storage controller and the storage array may also be less than the maximum transaction bandwidth between processing subsystem 110 and storage controller 120.

In a particular embodiment, storage subsystem 115 represents a storage capacity within information handling system 100. As such storage controller 120 can be connected to processing subsystem 110 locally to provide storage within information handling system 100, such as via a Serial or Parallel Advanced Technology Attachment (SATA/PATA) controller, a Small Computer Serial Interface (SCSI) controller, or a Fibre Channel controller that resides on a main system board of the information handling system, or that is implemented as a plug-in device, such as a SATA controller, a PATA controller, a SCSI controller, or a Fibre Channel controller on a PCI-E add-in card, and one or more storage devices can be connected to the storage controller to make up storage array 130. In another embodiment, storage subsystem 115 is external to, but directly attached to information handling system 100 through an external port of the processing subsystem, such as a Universal Serial Bus (USB) port, an IEEE-1394 (Firewire) port, or another external port.

Storage volumes 132 and 134 represent logical storage capacities within storage array 130. As such storage volumes 132 and 134 can represent different partitions on a single storage device, virtual volumes that are carved out of a sing larger redundant array of independent drives (RAID) volume spanning the storage enclosure(s) or part thereof, separate dedicated storage devices, separate dedicated arrays of storage devices, or a single array of storage devices that include different partitions for active data storage and for passive data storage. Where storage array 130 includes one or more arrays of storage devices, the arrays can conform to a RAID standard such as RAID 5, RAID 6, or another RAID standard as needed or desired. An example of a logical storage capacity includes a storage capacity that is accessible to an operating system, such as through a designated drive letter, a logical unit that is designated through a logical unit number (LUN) on a Fibre Channel network, a shared drive in a network attached environment, such as a laptop computer system, a storage volume in a virtualized peer storage system such as a Dell Equallogic™ storage system, another logical storage capacity, or a combination thereof.

Temporary storage device 140 represents a storage capacity that is associated with storage controller 120 that is used to temporarily store data that is to be written to storage volume 134. Thus temporary storage device 140 can be an included component of storage controller 120, such as a memory that is associated with the storage controller, or a separate component like a disk drive, a USB memory device, a removable memory device, or a combination thereof. In particular, temporary storage device 140 represents a storage capacity that is not mapped as a particular logical storage capacity of processing subsystem 110 or storage array 130, but that is available to store low priority data writes to the storage array in order to permit greater access to the storage array for high priority data access requests. As used herein, low and high priority data, low and high priority accesses, and low and high priority volumes are designated as such by a user of the various information handling systems and network storage systems described herein, or by an application associated with the various information handling systems and network storage systems, as needed or desired.

The data transfers between processing subsystem 110, storage controller 120, storage array 130, and temporary storage device 140 are preferably in accordance with one or more communication protocols. An example of a communication protocol includes a PCI-E protocol, a USB protocol, a SATA protocol, a SCSI protocol, an Ethernet protocol, a Fibre Channel protocol, an Internet-SCSI (ISCSI) protocol, a Fibre Channel over Ethernet (FCoE) protocol, another communication protocol, or a combination thereof.

In operation, application 112 provides for prioritized access to storage array 130. As such storage volume 132 is designated as an active storage volume, and is available to processing subsystem 110 for high priority access, and storage volume 134 is designated as a passive storage volume that is available for low priority access. For example, application 112 can include a database program that has an active database that is serviced by storage volume 132 and a passive database that is serviced by storage volume 134. When application 112 makes a high priority write access to storage array 130, the data transfer is provided from processing subsystem 110 to storage controller 120 in operation 160, and the storage controller provides the data transfer to active storage volume 132 in operation 162.

When application 112 makes a low priority write access to storage array 130, the data transfer is provided from processing subsystem 110 to storage controller 120 in operation 170, and the storage controller provides the data transfer to temporary storage device 140 in operation 172. By storing the low priority data in temporary storage device 140, the available data transfer bandwidth between storage controller 120 and storage array 130 is freed up to service high priority accesses. The low priority data transfers that are stored in temporary storage device 140 remain there until such time that storage controller 120 determines that the low priority data transfers can be written to passive storage volume 134 in operation 174. Storage controller 120 can determine that the low priority data transfers can be written to passive storage volume 134 when the storage controller detects that the available data transfer bandwidth between the storage controller and storage array 130 is not otherwise being utilized to service high priority data transfers, when a passive copy is requested to be made into an active copy, when a timeout occurs, when temporary storage device 140 reaches a predetermined capacity (such as when the temporary storage device becomes 90% full), when another transfer criteria is met, or when a combination of these conditions is met.

FIG. 2 illustrates another embodiment of an information handling system 200, similar to information handling system 100. Information handling system 200 includes a processing subsystem 210 similar to processing subsystem 110, and a storage subsystem 215 similar to storage subsystem 115. Processing subsystem 210 includes an application 212. Storage subsystem 215 includes a storage controller 220, and a storage array 230. Storage controller 220 includes a temporary storage device 222. Storage array 230 includes storage volumes 232 and 234. Storage controller 220 is connected to processor 210, and to storage array 230, as illustrated by the dashed lines.

Temporary storage device 222 represents a storage capacity that is associated with storage controller 220 that is used to temporarily store data that is to be written to storage volume 234, and is an included component of the storage controller, such as a flash memory device. Application 212 provides for prioritized access to storage array 230, such that storage volume 232 is designated as an active storage volume that is available for high priority access, and storage volume 234 is designated as a passive storage volume that is available for low priority access. For example, application 212 can include a database program that with an active database and a passive database. When application 212 makes a high priority write access to storage array 230, the data transfer is provided from the application to storage controller 220 in operation 260, and the storage controller provides the data transfer to active storage volume 232 in operation 262. When application 212 makes a low priority write access to storage array 230, the data transfer is provided from the application to storage controller 220, and the storage controller provides the data transfer to temporary storage device 222 in operation 270. The low priority data transfers that are stored in temporary storage device 222 remain there until such time that storage controller 220 determines that the low priority data transfers can be written to passive storage volume 234 in operation 272. Storage controller 220 can determine that the low priority data transfers can be written to passive storage volume 234 as described above.

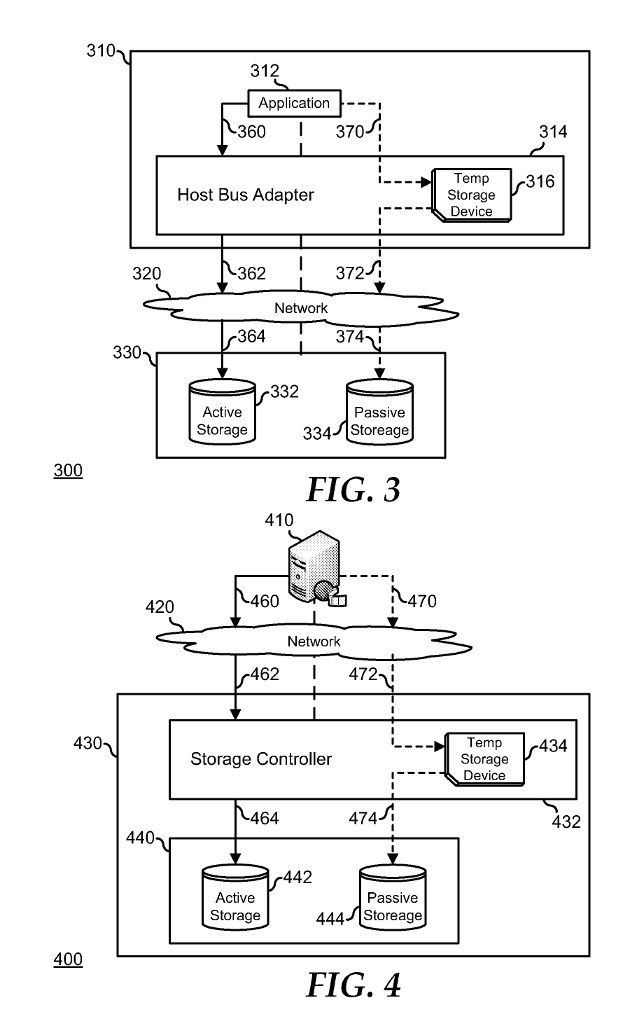

In another embodiment, a network storage system includes a server, a storage controller with a temporary storage device and a storage array that are connected together via a network. The storage array represents a storage area network (SAN) or other network attached storage capacity such as a cloud storage capacity. As such the storage controller can be included in a host bus adapter (HBA), in a network switch or other network device, in a SAN, or in another location that is operable to transfer data between the server and the storage array. FIGS. 3-5 illustrate different embodiments of network storage systems.

FIG. 3 illustrates a particular embodiment of a network storage system 300, including a server 310, a network 320, and a storage array 330. Server 310 includes an application 312 and a host bus adapter (HBA) 314. HBA 314 includes a temporary storage device 316. Storage array 330 includes storage volumes 332 and 334. Network 320 is connected to server 310 and to storage array 330, as illustrated by the dashed lines.

Storage array 330 represents a SAN or other network attached storage capacity such as a cloud storage capacity. Storage volumes 332 and 334 represent logical storage capacities within storage array 330 that are accessible to an operating system, such as through a logical units that are designated by LUNs, shared drives in a network attached environment, storage volumes in a virtualized peer storage system, other logical storage capacities, or a combination thereof. Temporary storage device 316 represents a storage capacity that is associated with HBA 314 that is used to temporarily store data that is to be written to storage volume 334, and can be an included component of the HBA, or can be a separate component. Temporary storage device 316 represents a storage capacity that is not mapped as a particular logical storage capacity of server 310 or storage array 330, but that is available to store low priority data writes to the storage array.

In operation, application 312 provides for prioritized access to storage array 330, with storage volume 332 designated as an active storage volume and storage volume 334 designated as a passive storage volume. When application 312 makes a high priority write access to storage array 330, the data transfer is provided from the application to HBA 314 in operation 360, the HBA provides the data transfer to network 320 in operation 362, and the network forwards the data transfer to active storage volume 332 in operation 364. When application 312 makes a low priority write access to storage array 330, the data transfer is provided from the application to HBA 314, and the HBA provides the data transfer to temporary storage device 316 in operation 370. By storing the low priority data in temporary storage device 316, the available data transfer bandwidth between HBA 314 and network 320 is freed up to service high priority accesses. The low priority data transfers that are stored in temporary storage device 316 remain there until such time that HBA 314 determines that the low priority data transfers can be provided to network 320 in operation 372. Network 320 then forwards the low priority data transfers to storage volume 334 in operation 374. HBA 314 can determine that the low priority data transfers can be written to passive storage volume 334 as described above.

FIG. 4 illustrates another embodiment of a network storage system 400, including a server 410, a network 420, and a network attached storage system 430. Network attached storage system 430 includes a storage controller 432, and a storage array 440. Storage controller 432 includes a temporary storage device 434. Storage array 440 includes storage volumes 442 and 444. Network 420 is connected to server 410 and to network attached storage system 430, as illustrated by the dashed lines. Network storage system 400 is similar to network storage system 300.

Network attached storage system 430 represents a SAN or other network attached storage capacity such as a cloud storage capacity. Storage volumes 442 and 444 represent logical storage capacities within storage array 440 that are accessible to an operating system, such as through logical units that are designated by LUNs, shared drives in a network attached environment, storage volumes in a virtualized peer storage system, other logical storage capacities, or a combination thereof. Temporary storage device 434 represents a storage capacity that is associated with storage controller 432 that is used to temporarily store data that is to be written to storage volume 444, and can be an included component of storage controller 432, or can be a separate component. Temporary storage device 434 represents a storage capacity that is not mapped as a particular logical storage capacity of server 410 or network attached storage system 430, but that is available to store low priority data writes to storage array 440.

In operation, an application running on server 410 provides for prioritized access to storage array 440, with storage volume 442 designated as an active storage volume and storage volume 444 designated as a passive storage volume. When server 410 makes a high priority write access to storage array 440, the data transfer is provided from the server to network 420 in operation 460, the data transfer is forwarded to storage controller 432 in operation 462, and the storage controller provides the data transfer to active storage volume 442 in operation 464. When server 410 makes a low priority write access to storage array 440, the data transfer is provided from the server to network 420 in operation 470 and the network forwards the data transfer to storage controller 432, and the storage controller provides the data transfer to temporary storage device 434 in operation 472. By storing the low priority data in temporary storage device 434, the available data transfer bandwidth between storage controller 432 and storage array 440 is freed up to service high priority accesses. The low priority data transfers that are stored in temporary storage device 434 remain there until such time that storage controller 432 determines that the low priority data transfers can be provided to storage volume 444 in operation 474. Storage controller 432 can determine that the low priority data transfers can be written to passive storage volume 444 as described above.

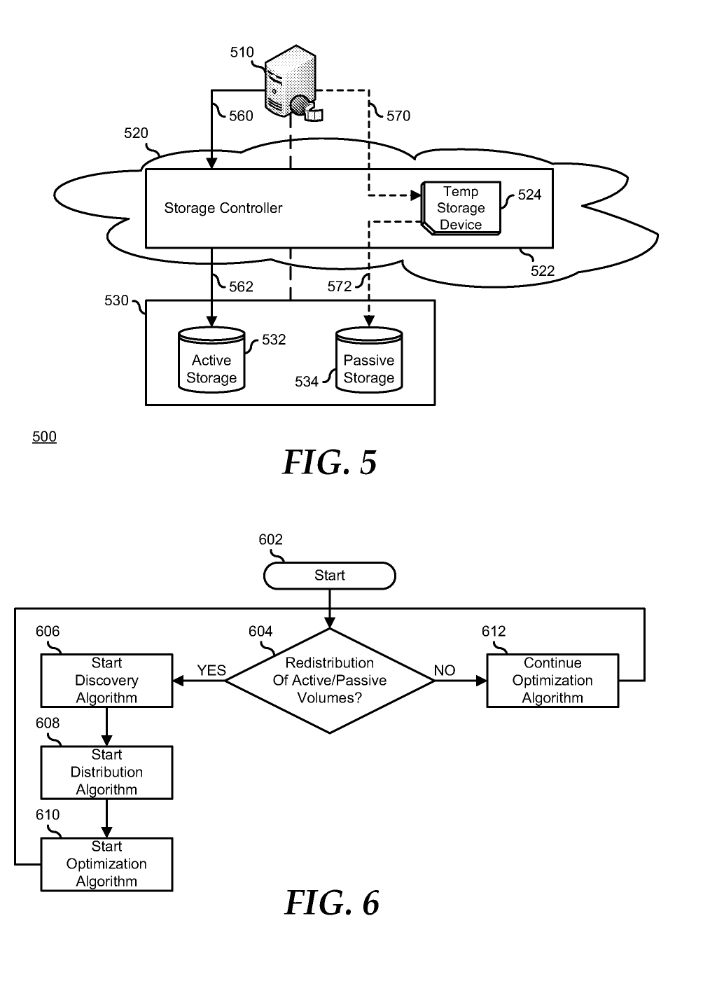

FIG. 5 illustrates another embodiment of a network storage system 500, including a server 510, a network 520, and a storage array 530. Network 520 includes a storage controller 522, and the storage controller includes a temporary storage device 524. Storage array 530 includes storage volumes 532 and 534. Network 520 is connected to server 510 and to storage array 530, as illustrated by the dashed lines. Network storage system 500 is similar to network storage system 300.

Storage array 530 represents a SAN or other network attached storage capacity such as a cloud storage capacity. Storage volumes 532 and 534 represent logical storage capacities within storage array 530 that are accessible to an operating system, such as through logical units that are designated by LUNs, shared drives in a network attached environment, storage volumes in a virtualized peer storage system, other logical storage capacities, or a combination thereof. Storage controller 522 represents a capability of an element of network 520 that is on a data path between server 510 and storage array 530, such as a switch, a router, another network element, or a combination thereof. Temporary storage device 524 represents a storage capacity that is associated with storage controller 522 that is used to temporarily store data that is to be written to storage volume 534, and can be an included component of the storage controller, or can be a separate component. Temporary storage device 522 represents a storage capacity that is not mapped as a particular logical storage capacity of server 510 or storage array 530, but that is available to store low priority data writes to the storage array.

In operation, an application running on server 510 provides for prioritized access to storage array 530, with storage volume 532 designated as an active storage volume and storage volume 534 designated as a passive storage volume. When server 510 makes a high priority write access to storage array 530, the data transfer is provided from the server to storage controller 522 in operation 560, and the storage controller provides the data transfer to active storage volume 532 in operation 562. When server 510 makes a low priority write access to storage array 530, the data transfer is provided from the server to storage controller 522, and the storage controller provides the data transfer to temporary storage device 522 in operation 570. By storing the low priority data in temporary storage device 522, the available data transfer bandwidth between network 520 and storage array 530 is freed up to service high priority accesses. The low priority data transfers that are stored in temporary storage device 522 remain there until such time that storage controller 522 determines that the low priority data transfers can be provided to storage volume 534 in operation 572. Storage controller 522 can determine that the low priority data transfers can be written to passive storage volume 534 as described above.

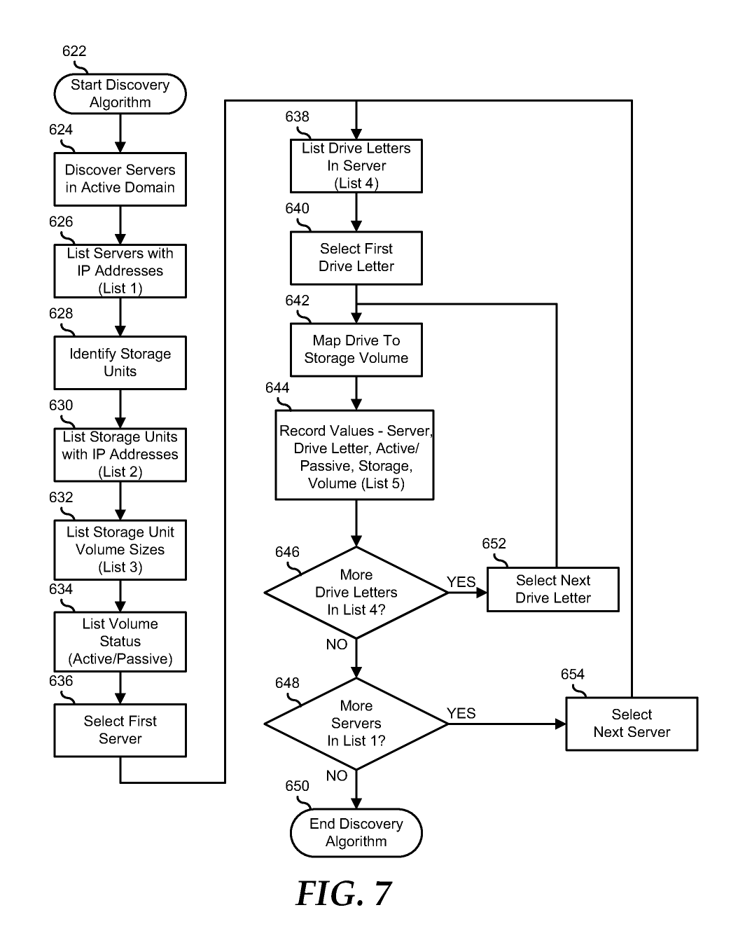

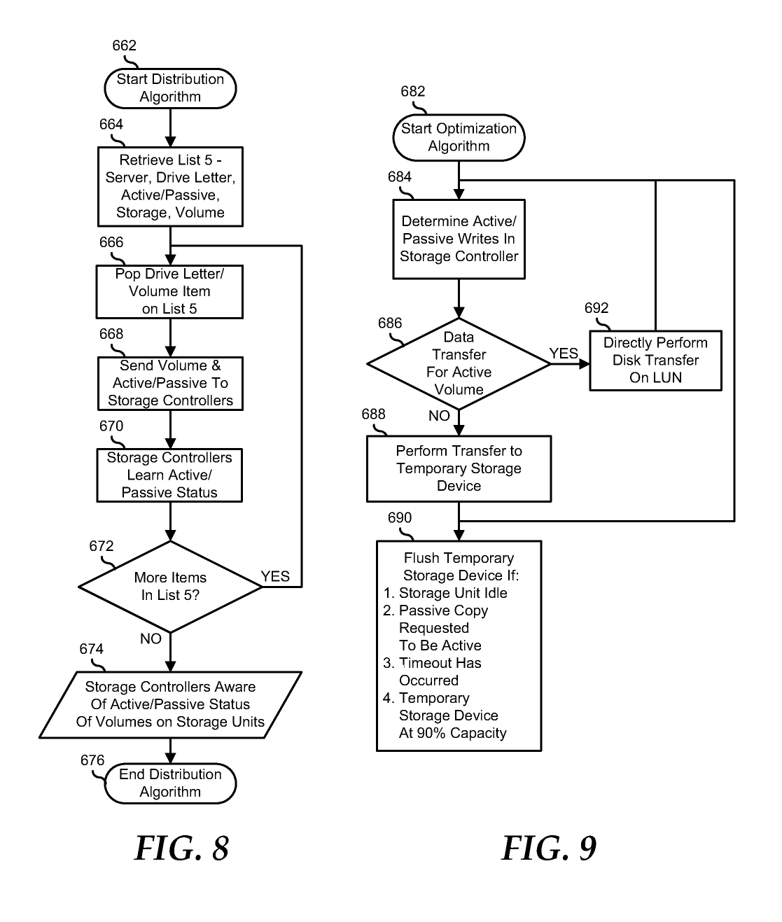

FIGS. 6-9 are flowcharts illustrating an embodiment of a method of implementing a storage system. FIG. 6 illustrates an overall method of implementing the storage system that starts in block 602. A decision is made as to whether or not the active and passive volumes in the storage system have been redistributed in decision block 604. For example, a new storage volume can be added to storage array 130 that is designated as either an active storage volume or a passive storage volume. If the active and passive volumes in the storage system have been redistributed, the YES branch of decision block 604 is taken and a discovery algorithm is started in block 606. The discovery algorithm is described below with respect to FIG. 7. The discovery algorithm determines what changes in the distribution of active and passive volumes have occurred in the storage system, where an active volume is associated with a high priority volume, and a passive volume is associated with a low priority volume. After the discovery algorithm has been executed, a distribution algorithm is started in block 608. The distribution algorithm is described below with respect to FIG. 8. The distribution algorithm determines how the storage system will manage the changes that have occurred in the storage system. After the distribution algorithm has been executed, an optimization algorithm is started in block 610 and processing returns to decision block 604 where a decision is made as to whether or not the active and passive volumes in the storage system have been redistributed. The optimization algorithm is described below with respect to FIG. 9. The optimization algorithm operates to manage the interaction with the active volumes and the passive volumes. If the active and passive volumes in the storage system have not been redistributed, the NO branch of decision block 604 is taken, the optimization algorithm is continued in block 612, and processing returns to decision block 604.

In a particular embodiment, the discovery algorithm and the distribution algorithm are implemented as an application, or as separate applications that run on a common host system that is connected to a storage array. In another embodiment, the discovery algorithm and the distribution algorithm are implemented as separate applications that run on two or more host systems that are connected to the storage array. In another embodiment, the optimization algorithm is implemented on a device that operates the temporary storage device, such as a storage controller that resides on a host system or that is implemented as a plug-in device of the host system, a storage controller or HBA associated with a server system, a storage controller associated with a network device or a storage array, another device that includes a temporary storage device, or a combination thereof.

FIG. 7 illustrates the discover algorithm of block 606 and starts in block 622. Servers in an active domain that includes the storage system are discovered in block 624, and the servers are listed in a first list, along with their respective IP addresses in block 626. Storage units in the active domain are identified in block 628, and the storage units are listed in a second list, along with their respective IP addresses in block 630. Volumes in each storage unit are listed in a third list, along with the volume sizes in block 632, and the volume statuses are determined in block 634. A first server is selected in block 636, and the drive letters in the server are listed in a fourth list in block 638. A first drive from the fourth list is selected in block 640, and the drive is mapped to a storage volume in block 642. The parameters for the drive and storage volume are listed in a fifth list in block 644. The fifth list includes the server, the drive letter, the volume, the active/passive status for the volume, and the volume size. A decision is made as to whether or not there are more drive letters on the selected server in decision block 646. If so, the YES branch of decision block 646 is taken, a next drive letter is selected in block 652, and processing returns to block 642 where the drive is mapped to a storage volume. If there are no more drive letters on the selected server, the NO branch of decision block 646 is taken, and a decision is made as to whether or not there are more servers in the active domain in decision block 648. If so, the YES branch of decision block 648 is taken, a next server is selected in block 654, and processing returns to block 638 where the drive letters in the server are listed. If there are no more servers in the active domain, the NO branch of decision block 648 is taken and the discovery algorithm ends in block 650.

FIG. 8 illustrates the distribution algorithm of block 608 and starts in block 662. The fifth list from block 644 that includes the parameters for the drives and storage volumes is retrieved in block 664. A drive letter/volume combination is popped from the fifth list in block 666, the volume and active/passive status for the volume are sent to the storage controllers on the active domain in block 668, and the volumes and active/passive statuses are learned by the storage controllers in block 670. A decision is made as to whether or not there are more drive letter/volume combinations in the fifth list in decision block 672. If so, the YES branch of decision block 672 is taken and processing returns to block 666 where a next drive letter/volume combination is popped from the fifth list. If there are no more drive letter/volume combinations in the fifth list, the NO branch of decision block 672 is taken, all storage controllers are then aware of the active/passive status of each volume, as illustrated in result block 674, and the distribution algorithm ends in block 676.

FIG. 9 illustrates the optimization algorithm of blocks 608 and 610 and starts in block 682. A storage controller determines if a write is to an active volume or a passive volume in block 684. A decision is made as to whether or not a data transfer is for an active volume in decision block 686. If so, the YES branch of decision block 686 is taken, the data transfer is directly performed in block 692, and processing returns to block 684 where the storage controller determines if a write is to an active volume or a passive volume. If the data transfer is not for an active volume, the NO branch of decision block 686 is taken, the transfer is performed to a temporary storage device in block 688, and processing returns to block 684 where the storage controller determines if a write is to an active volume or a passive volume. The storage controller flushes the temporary storage device to the passive storage volumes in block 690. The storage controller can determine to flush the temporary storage device when the storage controller detects that the available data transfer bandwidth is not otherwise being utilized to service high priority data transfers, when a passive copy is requested to be made into an active copy, when a timeout occurs, or when the temporary storage device reaches a predetermined capacity.

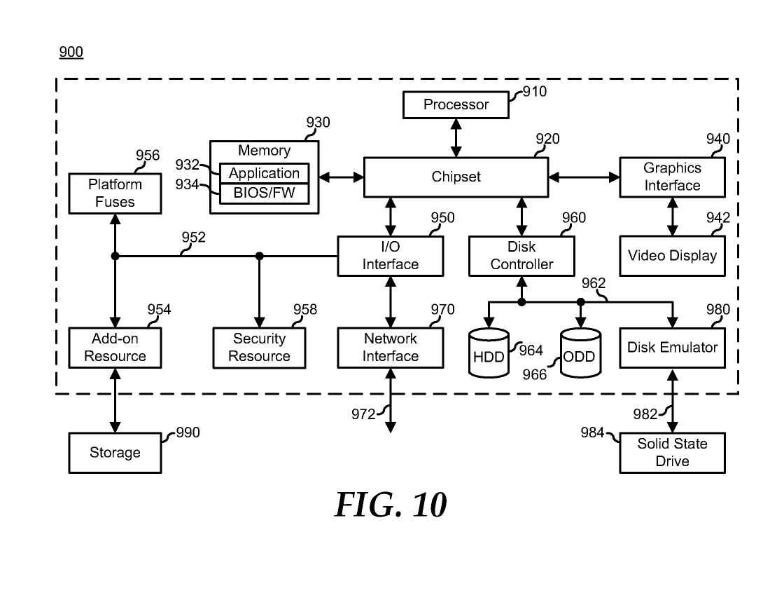

FIG. 10 is a block diagram illustrating an embodiment of an information handling system 900, including a processor 910, a chipset 920, a memory 930, a graphics interface 940, an input/output (I/O) interface 950, a disk controller 960, a network interface 970, and a disk emulator 980. In a particular embodiment, information handling system 900 is used to carry out one or more of the methods described herein. In another embodiment, one or more of the systems described herein are implemented in the form of information handling system 900.

Chipset 920 is connected to and supports processor 910, allowing the processor to execute machine-executable code. In a particular embodiment, information handling system 900 includes one or more additional processors, and chipset 920 supports the multiple processors, allowing for simultaneous processing by each of the processors and permitting the exchange of information among the processors and the other elements of the information handling system. Chipset 920 can be connected to processor 910 via a unique channel, or via a bus that shares information among the processor, the chipset, and other elements of information handling system 900.

Memory 930 is connected to chipset 920. Memory 930 and chipset 920 can be connected via a unique channel, or via a bus that shares information among the chipset, the memory, and other elements of information handling system 900. In another embodiment, processor 910 is connected to memory 930 via a unique channel. In another embodiment, information handling system 900 includes separate memory dedicated to each of the one or more additional processors. A non-limiting example of memory 930 includes static random access memory (SRAM), dynamic random access memory (DRAM), non-volatile random access memory (NVRAM), read only memory (ROM), flash memory, another type of memory, or any combination thereof.

Graphics interface 940 is connected to chipset 920. Graphics interface 940 and chipset 920 can be connected via a unique channel, or via a bus that shares information among the chipset, the graphics interface, and other elements of information handling system 900. Graphics interface 940 is connected to a video display 942. Other graphics interfaces can also be used in addition to graphics interface 940 as needed or desired. Video display 942 includes one or more types of video displays, such as a flat panel display, another type of display device, or any combination thereof.

I/O interface 950 is connected to chipset 920. I/O interface 950 and chipset 920 can be connected via a unique channel, or via a bus that shares information among the chipset, the I/O interface, and other elements of information handling system 900. Other I/O interfaces can also be used in addition to I/O interface 950 as needed or desired. I/O interface 950 is connected via an I/O interface 952 to one or more add-on resources 954. Add-on resource 954 is connected to a storage system 990, and can also include another data storage system, a graphics interface, a network interface card (NIC), a sound/video processing card, another suitable add-on resource or any combination thereof. I/O interface 950 is also connected via I/O interface 952 to one or more platform fuses 956 and to a security resource 958. Platform fuses 956 function to set or modify the functionality of information handling system 900 in hardware. Security resource 958 provides a secure cryptographic functionality and includes secure storage of cryptographic keys. A non-limiting example of security resource 958 includes a Unified Security Hub (USH), a Trusted Platform Module (TPM), a General Purpose Encryption (GPE) engine, another security resource, or a combination thereof.

Disk controller 960 is connected to chipset 920. Disk controller 960 and chipset 920 can be connected via a unique channel, or via a bus that shares information among the chipset, the disk controller, and other elements of information handling system 900. Other disk controllers can also be used in addition to disk controller 960 as needed or desired. Disk controller 960 includes a disk interface 962. Disk controller 960 is connected to one or more disk drives via disk interface 962. Such disk drives include a hard disk drive (HDD) 964, and an optical disk drive (ODD) 966, and can include one or more disk drive as needed or desired. ODD 966 can include a Read/Write Compact Disk (R/W-CD), a Read/Write Digital Video Disk (R/W-DVD), a Read/Write mini Digital Video Disk (R/W mini-DVD, another type of optical disk drive, or any combination thereof. Additionally, disk controller 960 is connected to disk emulator 980. Disk emulator 980 permits a solid-state drive 984 to be coupled to information handling system 900 via an external interface 982. External interface 982 can include industry standard busses such as USB or IEEE 1394 (Firewire) or proprietary busses, or any combination thereof. Alternatively, solid-state drive 984 can be disposed within information handling system 900.

Network interface device 970 is connected to I/O interface 950. Network interface 970 and I/O interface 950 can be coupled via a unique channel, or via a bus that shares information among the I/O interface, the network interface, and other elements of information handling system 900. Other network interfaces can also be used in addition to network interface 970 as needed or desired. Network interface 970 can be a network interface card (NIC) disposed within information handling system 900, on a main circuit board such as a baseboard, a motherboard, or any combination thereof, integrated onto another component such as chipset 920, in another suitable location, or any combination thereof. Network interface 970 includes a network channel 972 that provide interfaces between information handling system 900 and other devices that are external to information handling system 900. Network interface 970 can also include additional network channels.

Information handling system 900 includes one or more application programs 932, and Basic Input/Output System and Firmware (BIOS/FW) code 934. BIOS/FW code 934 functions to initialize information handling system 900 on power up, to launch an operating system, and to manage input and output interactions between the operating system and the other elements of information handling system 900. In a particular embodiment, application programs 932 and BIOS/FW code 934 reside in memory 930, and include machine-executable code that is executed by processor 910 to perform various functions of information handling system 900. In another embodiment, application programs and BIOS/FW code reside in another storage medium of information handling system 900. For example, application programs and BIOS/FW code can reside in HDD 964, in a ROM associated with information handling system 900, in an option-ROM associated with various devices of information handling system 900, in storage system 990, in a storage system associated with network channel 972, in another storage medium of information handling system 900, or a combination thereof. Application programs 932 and BIOS/FW code 934 can each be implemented as single programs, or as separate programs carrying out the various features as described herein.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A storage system comprising:
a storage controller;
a storage array coupled to the storage controller, wherein the storage array is adapted to operate as a redundant array of independent drives (RAID) array, the storage array including:
a first storage volume designated as a high priority storage volume; and
a second storage volume designated as a low priority storage volume; and
a temporary storage device coupled to the storage controller;
wherein the storage controller is adapted to:
receive a high priority data transfer and store the high priority data transfer on the first storage volume;
receive a low priority data transfer and store the low priority data transfer on the temporary storage device; and
move the low priority data transfer to the second volume in response to a condition of the storage system.

2. The storage system of claim 1, wherein the condition of the storage system includes a bandwidth utilization of the storage array.

3. The storage system of claim 1, wherein the condition of the storage system includes designating the second storage volume as a high priority storage volume.

4. The storage system of claim 1, wherein the condition of the storage system includes the temporary storage device being filled above a predefined capacity level.

5. The storage system of claim 1, wherein the storage controller comprises the temporary storage device.

6. The storage system of claim 1, wherein the temporary storage device is a removable storage device coupled to the storage controller.

7. The storage system of claim 1, further comprising:
an information handling system coupled to the storage controller, the information handling system including an application adapted to provide the high priority data transfer and the low priority data transfer to the storage controller;
wherein the storage controller is a RAID controller.

8. The storage system of claim 1, wherein the storage array is included in a storage area network.

9. The storage system of claim 8, wherein:
the storage controller comprises a host bus adapter associated with an information handling system; and
the storage controller is coupled to the storage array through a network.

10. The storage system of claim 8, wherein:
the storage controller is included in the storage area network; and
the high priority data transfer and the low priority data transfer are received by the storage controller via a network.

11. The storage system of claim 8, wherein:
the storage controller is included in an element of a network;
the high priority data transfer and the low priority data transfer are received by the storage controller from an information handling system coupled to the network; and
the high priority data transfer and the low priority data transfer are stored by the storage controller on the storage array via the network.

12. A method for storing data, the method comprising:
designating a first storage volume of a redundant array of independent drives (RAID) storage array for high priority data transfers;
designating a second storage volume of the RAID storage array for low priority data transfers;
receiving at a storage controller a high priority data transfer including first data;
storing the first data on the first storage volume;
receiving at the storage controller a low priority data transfer including second data;
storing the second data on a storage device of the storage controller; and
moving the second data to the second storage volume in response to a change in a condition of the RAID storage array.

13. The method of claim 12, wherein the condition of the RAID storage system includes a bandwidth utilization of the RAID storage array.

14. The method of claim 12, further comprising:
after storing the second data on the storage device, designating the second storage volume for high priority transfers;
wherein the condition of the RAID storage system includes determining that the second storage volume has been designated for high priority transfers.

15. The method of claim 12, wherein the condition of the RAID storage system includes the temporary storage device being filled above a predefined capacity level.

16. The method of claim 12, wherein the storage device is a removable storage device coupled to the storage controller.

17. Machine-executable code for a client hosted virtualization system, wherein the machine-executable code is embedded in a non-transitory storage medium and includes instructions for carrying out a method, the method comprising:
designating a first storage volume of a redundant array of independent drives (RAID) storage array for high priority data transfers;
designating a second storage volume of the RAID storage array for low priority data transfers;
receiving at a storage controller a high priority data transfer including first data;
storing the first data on the first storage volume;
receiving at the storage controller a low priority data transfer including second data;
storing the second data on a storage device of the storage controller; and
moving the second data to the second storage volume in response to a change in a condition of the RAID storage array.

18. The machine-executable code of claim 17, wherein the condition of the RAID storage system includes a bandwidth utilization of the storage array.

19. The machine-executable code of claim 17, the method further comprising:
after storing the second data on the storage device, designating the second storage volume for high priority transfers;
wherein the condition of the RAID storage system includes determining that the second storage volume has been designated for high priority transfers.

20. The machine-executable code of claim 17, wherein the condition of the RAID storage system includes the temporary storage device being filled above a predefined capacity level.
